(19) United States
(12) Patent Application Publication
(10) Pub. No.: US 2015/0015374 A1
(43) Pub. Date: Jan. 15, 2015

(54) SYSTEM, METHOD, COMPUTER PROGRAM AND DATA SIGNAL FOR THE COLLECTION, USE AND DISSEMINATION OF INFORMATION

(71) Applicant: EITS GLOBAL LIMITED SEZC, Grand Cayman (KY)

(72) Inventors: Robert Nicholas Sofoulis, Attadale (AU); David McWilliams, Attadale (AU); Steve Bramley, Attadale (AU)

(73) Assignee: EITS GLOBAL LIMITED SEZC, Grand Cayman (KY)

(21) Appl. No.: 14/376,068

(22) PCT Filed: Jan. 31, 2013
(86) PCT No.: PCT/AU2013/000084

§ 371 Date: Jul. 31, 2014

(30) Foreign Application Priority Data
Jan. 31, 2012 (AU) 2012900353
Oct. 10, 2012 (AU) 2012904429

(51) Int. Cl. G06K 7/10

(52) U.S. Cl. CPC G06K 7/10009; G06K 7/10475
USPC 340/10.3

(57) ABSTRACT

The embodiments described herein relate to a system, method, computer program and data signal for the collection of information. The system comprises at least one computing system arranged to receive information from one or more unique identifying devices, wherein the computing system receives the information from the one or more unique identifying devices and processes the information in real time to determine whether an action should be taken.

### TECHNICAL FIELD

The present invention generally relates to a system, method, computer program and data signal for the collection, use and dissemination of information. The invention finds particular, but not exclusive, use in the collection of information from mobile or portable devices, including but not limited to ‘smart’ cards, radio-frequency identification (RFID) enabled devices, near-field communication devices, magnetic strip devices and other devices capable of holding and/or providing information.

### BACKGROUND ART

In today's world the effective collection, use and dissemination of information allows organisations to readily adapt to changes, to employ their resources in a more efficient manner, and to provide a safer and more secure environment. More recently, there has been an emphasis on the collection, use and dissemination of information in ‘real time’.

In particular, the growth of social media websites and the corresponding growth of a culture that expects ‘real time’ and instantaneous access to information, updates and access to products and services has placed additional pressures on conventional media and retail organisations.

In more detail, the pressure arises from the need to collect, use and disseminate information that is accurate and verifiable. It is therefore important that the information is not sabotaged either in the process of collecting, using or disseminating the information.

The collection of information relating to people is particularly important, for safety and other operational reasons. For example, at a music concert, it would be useful to be able to track the presence, movement and alcohol consumption of each concert goer, in order to pre-empt any potential issues (e.g. overconsumption of alcohol). Similar considerations may apply at a work site. For example, at a mine site, it may be extremely important to track the location of all personnel, to prevent or at least minimize accidents.

In yet another example, it is important for a hospital to be able to identify the location and treatment history of all patients.

Currently, there are no systems which allow for the automatic and continuous collection and reporting of information relating to a person's activities. Large organisations often have a ‘clock in/clock off’ station for workers to log in/off upon arriving and leaving work. However, the organisation is unable to determine the person's movements or actions during their time at work. Moreover, as such solutions require a positive action from the person, the accuracy of the information relies on the person taking the appropriate steps to log in/off. For example, if there is a fire on the premises and a person leaves the premises without logging off then it is not possible to account for the whereabouts of the person.

Similarly at sporting, music and similar events, there is no control on who attends an event, nor control on what happens during the event. Currently most tickets for events are purchased online or over the telephone. The tickets are then posted to the purchaser who may have purchased numerous tickets for other individuals. Other than having the postal address and credit card details of the purchaser, the event organisers have no means of identifying the potential attendees of the event.

For some events, the ticket buyers are also provided with security wrist bands. However, these are typically provided by a third party which is separate to the ticket sellers. Typically, the ticket seller would dispatch the tickets and then send a list of the ticket purchasers to the third party, who then in turn dispatch the wrist bands. As a result it is extremely difficult to link each individual wrist band with its specific ticket, and therefore difficult to track wrist bands. This therefore allows people to duplicate wrist bands as the wrist bands cannot be identified and therefore disabled.

The wrist bands typically incorporate an RFID which can be scanned. Each RFID has a unique identifier. Upon scanning, the information on the RFID is verified against a database on a server. It is therefore essential, that the scanning device remain logged onto the network. This is easily resolved where the event is held at a purpose built location where the infrastructure such as optic fibres and scanning stations is installed (such as may be the case at a theme park). However, where the site is temporary, as at most music festivals, then the expense in setting up temporary infrastructure can outweigh the benefit. The full potential of a wrist band is therefore not realised.

An RFID wrist band can be used to access stored information. For example, a purchaser may associate money with the RFID and use the wrist band to purchase items within the event. However, this will require that the scanning device remain logged into the server so that upon scanning, the server can verify whether the purchaser has sufficient funds, and if so adjust the funds associated with that wrist band on the server. Should the system crash the owner of the wrist band is no longer able to access those funds.

Similar considerations apply in a more general setting. Customers generally use credit cards to effect purchases in traditional retail stores and online. Credit cards are open to fraud and misuse, as they are an old technology that can easily be cloned and/or faked. In addition to tracking people, there is also a need to develop a technology that allows a consumer, a merchant (retailer) or a financial institution to easily and accurately track the use of credit, and if necessary, prevent misuse of the credit.

The preceding discussion of the background art is intended to facilitate an understanding of the present invention only. The discussion is not an acknowledgement or admission that any of the material referred to is or was part of the common general knowledge as at the priority date of the application.

### SUMMARY OF INVENTION

In one aspect, the invention provides a system for the collection of information comprising at least one computing system arranged to receive information from one or more unique identifying devices, wherein the computing system receives the information from the one or more unique identifying devices and processes the information in real time to determine whether an action should be taken.

The system may further comprise a plurality of scanning devices arranged to scan the at least one unique identifying device. The plurality of scanning devices may establish a communications network within a predetermined area.

The communications network may utilise one of a wireless computing communication standard and a wireless telecommunication standard.

The system may assign each one of the one or more unique identification devices to a person or object.

The scanning device may be arranged to automatically scan the one or more unique identifying devices when the one or more unique identifying devices fall within a prescribed range of the scanning device.

The unique identifying device may include a radio frequency identification chip.

The computing system may further comprise a database arranged to store the information collected.

The system may further comprise a comparison module arranged to compare the information received to information in the database.

In a second aspect the invention may provide a method for issuing a unique identifying device associated with a user or object, comprising the steps of activating a unique identifying device to meet predetermined security requirements; assigning permissions to the unique identifying device; associating the unique identifying device with a person or object, wherein actions by the person or object are loggable by a system interacting with the device.

The method may comprise the further step of activating the device by the steps of reading an identification code of the device and a bar code associated with the device and amalgamating the identification code and bar code with a designated code to produce the unique code. The code may be encrypted.

The method may comprise the further step of activating a plurality of unique identification devices in a substantially simultaneous or contemporaneous manner, whereby each unique code associated with each device incorporates information related to the devices which were activated contemporaneously.

The activation of the unique identification devices may be conducted simultaneously.

In a third aspect the invention may provide a system for determining whether an action should be taken comprising at least one computing system arranged to receive information from one or more unique identifying devices, the information pertaining to at least one action initiated by a user or object, wherein the computing system includes a database and a processor arranged to receive the information, process the information to determine whether the action falls within a predetermined set of allowable actions.

The information may be collected from the one or more unique identifying devices via a telecommunications infrastructure.

Each of the one or more unique identification devices may be associated with a particular person or object.

The unique identification device may be activated upon the person or object entering a specific area.

The unique identification device may be activated upon the person or object initiating an action.

If the actions falls within the set of predetermined actions, the processor may issue a command to allow the action.

If the action falls outside the set of predetermined actions, the processor may issue a command to disallow the action.

The action may further include sending an electronic signal to the person or object.

The action may further include sending an electronic signal to a third party.

The electronic signal may include a message.

The action initiated by the user may be a request to effect a financial transaction.

In a fourth aspect, the invention provides a computer program including at least one command, which, when executed on a computing system, is arranged to perform the method steps of the second aspect of the invention.

In a fifth aspect, the invention provides a computer readable medium incorporating a computer program in accordance with the fourth aspect of the invention.

In a sixth aspect, the invention provides a data signal encoding at least one command and being arranged to be receivable by at least one computing device, wherein, when the encoded command is executed on the computing system, the computing system performs the method steps of the second aspect of the invention.

Generally, embodiments of the invention provide an identifying system for collecting, displaying and sending information related to a unique identification device, the information being made available for viewing and analysing in real time.

The system may incorporate temporary infrastructure to scan collect and store information. The infrastructure may establish a Wi-Fi or other communication network within a predetermined area. Alternatively the infrastructure may use an existing network (e.g. 3G) for the transfer of information. This would be useful where the system is to be employed across multiple sites remote from each other, or where the system is to be employed in a small area. By using an existing system the cost is also kept to a minimum.

The information may be collected by scanning or by directly uploading information to the system from social media or through a designated portal.

The system may assign a unique identification means to each item information is to be collected from. These items may be in the form of people at a music event, patients at a hospital, workers at a mine site; goods in a warehouse, items of mail or any other object.

The system may also comprise a scanning means for scanning the identification means when the identification falls within the prescribed range of the scanning means. The scanning means may be in the form of a scanning unit whereby an operator is required to be within a short distance of the identification means and actively scan the identification means in order to scan the identification means. In another form, the scanning means allows multiple and continuous scanning of identification means, such as may be the case when events finish and spectators leave an event on mass.

The identification means may allow for proximate scanning or remote scanning, or a combination of both.

The unique identification device may be in the form of an RFID. One or more RFID's may be located in a ticket, wristband, token, or threaded into material. THE RFID's may be in the form of a long range or short range chip, and may have a power source. THE RFID's may also be coupled with gyrometers.

Embodiments of the invention provide a ticket system for issuing a ticket to gain entrance to an event, such as a music festival, whereby a ticket purchaser simultaneously receives a ticket and a unique identification device.

In an alternate embodiment, there may be provided a ticket system for issuing a ticket to gain entrance to an event, such as a music festival, whereby a ticket purchaser receives a ticket having a unique code and a unique identification device, whereby the ticket and identification device are linked such that when the ticket is cancelled, such as may be required when reported stolen, the identification device can easily be identified and also disabled.

In yet another embodiment, there is provided a system for issuing a unique identification device and a ticket, whereby the ticket is linked to the identification device, the system comprises the following method:
activation of a unique identification device to meet predetermined security requirements;
assigning permissions to the unique identification device;
printing ticket;
scanning the unique identification device and linking the unique identification device to the ticket being printed, such that either the ticket or unique identification device can be identified from details of either the ticket or the unique identification device.

In the event that an issued ticket is lost/stolen a new ticket may be printed and issued along with a new unique identification device. When the ticket is reissued the system identifies the old unique identification device issued with the lost/stolen ticket and updates the system to indicate the old unique identification device is no longer valid. This prevents lost/stolen unique identification device to be used by other parties. During the reissue process the permissions previously assigned to the old unique identification device may be transferred to the new unique identification device.

Preferably when activating the electronic device a unique code is written onto the electronic device.

Preferably, the unique code is created by:
reading an identification code of the electronic device and a bar code associated with the electronic device;
amalgamating the identification code and bar code with a designated code to produce the unique code.

The unique code also incorporates encryption.

The unique code may provide the electronic device with a security structure which will prevent tampering and cloning of the electronic device.

Preferably the unique identification device are activated in batches, whereby the unique code incorporates the specific batch details. The unique identification device of a particular batch can be designated with certain attributes/permissions. For instance, a specific batch may be distributed to persons who have purchased a general entry ticket, whilst another batch may be distributed to persons who have purchased a VIP entry ticket. These attributes are considered a first level of validation whereby scanning of multiple people can be conducted quickly with immediate verification.

The ticket and unique identification device may be dispatched together.

The scanning and activation of the unique identification device may be conducted simultaneously.

In one embodiment the ticket and unique identification device are separate items.

In another embodiment the ticket and unique identification device are incorporated. Preferably the ticket and the unique identification device may be easily separated.

Preferably when printing the ticket, relevant information from the ticket is copied and printed to the unique identification device. This may include the ticket number, bar code, and details of the concert.

Preferably when scanning the unique identification device a scanning means scans and records the unique code, identification code or bar code or a combination of all.

Activation of the unique identification device may occur at any time and the activated unique identification device can be stored. When the unique identification device are required, the batch numbers can then have properties attributed thereto. As there is no need to process each unique identification device to assign these properties this process may be conducted remotely.

By assigning a batch to each unique identification device the unique identification device can be easily tracked.

The unique identification device may be in the form of an electronic device. Preferably the electronic device is in the form of a RFID. The RFID may be incorporated in a wrist band. Preferably the RFID circuit breaks when the wrist band is removed from a persons' wrist.

Preferably the system allows each unique identification device to be personalised. This information can then be used by organisers to identify who is coming to the event, and the demographics of the people allowing targeted marketing as well as ensuring the appropriate facilities are available at the event.

Upon receipt of the unique identification device the recipient may log on to a website using the unique code, identification code or bar code linked to the unique identification device or the ticket number. Once on the website an account may be created, or the person can log on to an existing account.

The person may also link their account to their account on other social network sites, such as Facebook®. This information may then be written to their unique identification device. Once the unique identification device has been personalised the person may participate in associated activities pre and post events. They may purchase merchandise, upgrade their ticket to gain access to other zones. It also allows them to link up with other friends who also attend the event.

When personalising the unique identification device the person may list any medical conditions and provide emergency contact details. Should the person become ill, a medical officer can scan their unique identification device and identify this information. If friends who are also in attendance at the event are also linked to the persons account a message may also be sent for them which will appear next time they are scanned.

From their account the person is also able to link funds to their unique identification device for use during the event.

The unique identification device may also be updated with details of the persons age once verified by an authorised person.

Once personalised, the person may update their unique identification device at the event.

When personalising a unique identification device, details on the server are updated to reflect the personalised information. This information may then be pushed to the unique identification device, or the unique identification device may be updated when scanned next.

A personalised message may be assigned to the unique identification device. At the time the unique identification device is next scanned the message will appear on the scanning unit and can be shown to the person.

The unique identification device may not allow entry until such time as the unique identification device is personalised.

The unique identification device may store all essential information. This will still allow the scanning of the unique identification device should the scanning unit be off-line. When the scanning unit is back on line this information is then sent to the server. In one aspect of the invention the unique identification device stores all information with the exception of the funds which have been attributed to the unique identification device.

The system may also incorporate an App which may be accessed via a phone. The app may provide access to the persons account, provide information as to where linked friends have previously been scanned, allows a communal money fund, allow funds to be transferred to other unique identification device, provides event information. The App may be specific to that event.

Preferably the unique identification device is scanned upon every purchase. This allows the organisers to identify what people are purchasing. Should the person need emergency attention, it will also allow medical staff to identify what the person may have consumed.

Based on transaction history, unique rewards and giveaways may be issued to unique identification device which may be collected at various outlets.

The unique identification device may be issued with an unlock key. The unlock key will need to be used to transfer the ticket to another person. The reselling of the ticket may result in a fee being charged by the organisers such that they gain a percentage of the resale value.

The embodiment further provides a system of collecting information from a unique identification device as herein before described.

The system comprises a scanning unit which scans the unique identification device at various stations, which may be mobile or fixed. For instance, the scanning stations may be located at entry gates, at retail outlets, such as refreshment stands, designated zones, e.g. VIP sections, first aid stations.

Preferably the scanning unit may store data in the event it is off-line. The stored data may then be uploaded to the server when it is back online.

The scanning unit may display the number of people who have entered a zone, and disallow the scanning of further unique identification device for entry into that area until people have left that zone. This assists with crowd control and allows volumes to be readily monitored. It also provides a history of the more popular areas of an event. This information can then be used to identify the most appropriate areas for marketing, event facilities. The information can also be used to react in real time to possible issues arising due to crowd movement.

The scanning unit may be locked after a period of inactivity.

Preferably the scanning unit displays information relevant to the unique identification device.

Preferably the scanning unit allows the authorised operator to update details specific to the unique identification device. For instance, if a person has been ejected from a zone, the authorised operator may scan that persons unique identification device and update details attributed to that unique identification device to reflect the ejection. Should that person be scanned again by another scanning unit the operator will be notified of the ejection.

The unique identification device may be scanned by remote scanners whereby a period in one location may be activate a transfer of information whereby that information is uploaded to a website and may be used to update the persons profile in an account, such as a Facebook® account. If at a concert, this information may be cross referenced with the lineup schedule and the artist performing at that time, information may be sent to the account indicating that you liked that artist.

The present invention provides a ticket incorporating a unique identification device, whereby the unique identification device may be removed from the ticket and attached to the ticket purchaser, their phone or other belonging.

The ticket may also comprise one or more secondary identification means which may be removed and used according to its designated use. For instance the secondary identification means may be a sticker which may be removed and attached to the windscreen of the car to show parking permission. The secondary identification means may have a bar code for scanning by operators.

The unique identification device may also be provided to staff, whereby each staff group (e.g. cleaners, bar staff, security, etc) have different unique identification device, each having their own permissions and authorisations. This allows for monitoring of staff work hours. The unique identification device may send GPS location to track whereabouts of staff.

The unique identification device may be integrated with third party accreditation lists, volunteer lists, prior staff.

The unique identification device allows collection of information relating to the persons activities.

### BRIEF DESCRIPTION OF THE DRAWINGS AND EMBODIMENT

Further features of the present invention are more fully described in the following flow charts of several non-limiting embodiments. These flow charts are to be read in conjunction with the above description and are included solely for the purposes of exemplifying the present invention.

FIG. 1 is a diagram illustrating a server in accordance with an embodiment of the present invention;

FIG. 2 is an overview of the system in accordance with an embodiment of the present invention;

FIG. 3 depicts a flow chart relating to the collection and flow of collected information in the system according to an embodiment of the invention;

FIG. 4 depicts a flow chart of the process relating to activation of the unique identification device;

FIG. 5 depicts a flow chart relating to the issue of tickets with unique identification device;

FIG. 6 depicts an alternate flow chart relating to the activation of the unique identification device;

FIG. 7 depicts a flow chart relating to activation of a user account in accordance with an embodiment of the invention;

FIG. 8 depicts a flow chart relating to a traditional purchase process enhanced by utilising a unique identification device in accordance with an embodiment of the invention;

FIG. 9 depicts a flow chart relating to a hybrid purchase process in accordance with an embodiment of the invention; and

FIG. 10 depicts a flow chart relating to a purchase process in accordance with an embodiment of the invention.

### DESCRIPTION OF AN EMBODIMENT

### Introduction

The present invention relates generally to a system, method, computer program and data signal for the collecting use, and dissemination of electronic information. In particular, the embodiment described herein is utilised to collect, use and disseminate information associated with a person, credit account or object.

In a broad aspect of the embodiments described herein there is provided a system for the collection of information comprising at least one computing system arranged to receive information from one or more unique identifying devices, wherein the computing system receives the information from the one or more unique identifying devices and processes the information in real time.

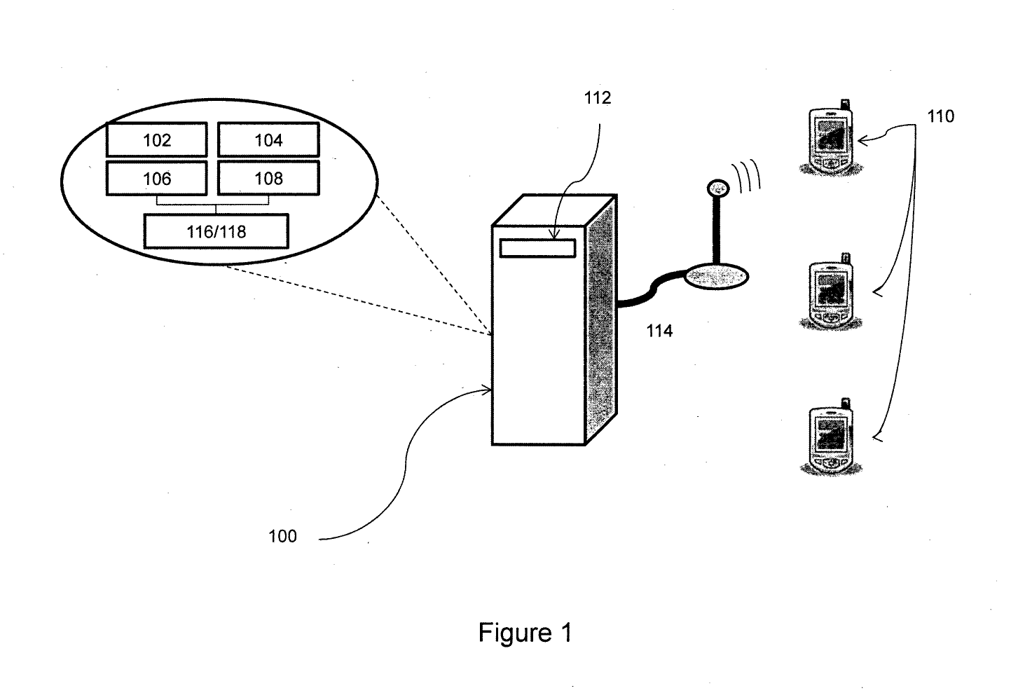

The method of the embodiment can be codified in a computing system, such as the computing system shown at FIG. 1.

In FIG. 1 there is shown a schematic diagram of a computing system, which in this embodiment is a computing device 100 suitable for use with an embodiment of the present invention. The computing device 100 may be used to execute application and/or system services such as a system and method for the collection, use and dissemination of information in accordance with an embodiment of the present invention.

With reference to FIG. 1, the computing device 100 may comprise suitable components necessary to receive, store and execute appropriate computer instructions. The components may include a processor 102, read only memory (ROM) 104, random access memory (RAM) 106, an input/output devices such as disc drives 108, remote or connected input devices 110 (such as a RFID chip reader, a barcode scanner, a magnetic strip reader or any means to input information received from another computing device, such as a ‘desktop’ personal computer), and one or more communications link(s) 114.

The computing device 100 includes instructions that may be installed in ROM 104, RAM 106 or storage device 112 and may be executed by the processor 102. There may be provided a plurality of communication links 114 which may variously connect to one or more external (remote) devices 110 such as servers, personal computers, terminals, wireless or handheld computing devices (such as the multi-purpose reader described herein), or mobile communication devices such as a mobile (cell) telephone. It will also be understood that the external (remote) devices may be ‘passive’ devices, such as a near-field communication device, or a radio-frequency identification (RFID) device. At least one of a plurality of communications link 114 may be connected to an external computing network through a telecommunications network.

In one particular embodiment the device may include a database 116 which may reside on the storage device 112. It will be understood that the database may reside on any suitable storage device, which may encompass solid state drives, hard disc drives, optical drives or magnetic tape drives. The database 116 may reside on a single physical storage device or may be spread across multiple storage devices.

The computing device 100 includes a suitable operating system 118 which may also reside on a storage device or in the ROM of the computing device 100. The operating system is arranged to interact with the database and with one or more computer programs to cause the server to carry out the steps, functions and/or procedures in accordance with the embodiments of the invention described herein.

The system, in one embodiment, utilises the storage device 112 and/or the database 116 to contain (either temporarily or permanently) information pertaining to a person or an object, including but not limited to the physical location of the person or object, and one or more attributes of the person or object (e.g. how many alcoholic drinks have been consumed by the person, how much money the person has spent, etc.). The database is arranged to receive the information via any suitable module or component. That is, the computing device 100 may connect to a remote device 110 such as the remote device described hereinafter.

In more detail, the system, in the embodiment described hereinbelow, is comprised of a number of components which operate collectively to provide the ability to collect, use and disseminate information with regard to the movement and activity of a person or object. The activity of a person may include their actions within a predefined, known space (e.g. how many drinks a person has bought at an event), or their more general activity (e.g. their spending habits over the last week). Importantly, the embodiment allows for such information to be processed and interpreted in real time, so that action may be taken if a predetermined threshold, limit or other condition is reached.

This is achieved by the interplay of two principal components, a computing system (server) which is connected to an infrastructure of information collection devices, and a series of unique identification devices, each of which are associated with a particular person or object.

At a very high level, as people go about their daily lives (or go about their activities in a specific space, such as at a concert or other entertainment event), the unique identification device is used, both in a passive manner and in an active manner, to provide information to the computing system via the infrastructure of information collection devices.

The computing system receives the information and processes the information in real time, to determine whether any action is required as a consequence of the information received. If action is required, the computing system initiates the relevant action. This may include sending a message to the person associated with the unique identification device, or where appropriate, informing a third party.

The ensuing description provides an overview of the components of one embodiment of the system. Description is provided with regard to the unique identification device, the computing system, which includes a database and a web interface, and the interplay between these components.

Furthermore, two examples of the potential use of the embodiment are provided. The first example relates to a specific use, namely the monitoring of transactions and behaviour at an event (such as a music concert). The second example relates to a more general use, where an embodiment of the invention is employed to manage the transactions of a consumer.

Other aspects of the broad inventive concept relate to a corresponding method, computer program, computer readable media and data signal.

Example Unique Identification Devices

IT will be understood that in the ensuing description, reference will be made to a unique identification device. A unique identification device is any device capable of holding and/or storing information, which may be read by an electronic device. That is, a unique identification device may include but is not limited to a RFID chip, a NFC chip, a smart card, a conventional mobile (cell) phone or a smartphone.

### Detailed Embodiment

### Ticket Application

In the ensuing description, reference will be made to the use of a “ticket” incorporating a RFID chip as part of an example embodiment. It will be understood that this is to be construed as one example only of a unique identification device and the possible use of the unique identification device within the broader system described herein. In a later section, a broader embodiment arranged to allow and track purchases at merchants (retail stores) will be described in more detail.

Returning to the ticket embodiment, the embodiment provides a ticket, wristband, token, or RFID chip threaded into material (to form a wristband, necklace, lanyard or other wearable device). THE RFID chip may be a long range or short range chip, and may have a power source, depending on the type of application. THE RFID may also be coupled with a sensor such as a gyrometer, with non-volatile memory, or with a processor (to create a WISP—Wireless Identification and Sensing Platform).

In the embodiment described, the ticket and/or wristband provide a ticket system for issuing a ticket to gain entrance to an event, such as a music festival, whereby a ticket purchaser simultaneously receives a ticket and a unique identification device.

In an alternate embodiment, there may be provided a ticket system for issuing a ticket to gain entrance to an event, such as a music festival, whereby a ticket purchaser receives a ticket which has a unique code and a unique identification device, whereby the ticket and identification device are linked such that when the ticket is cancelled, such as may be required when reported stolen, the identification device can easily be identified and also disabled.

The unique identification device and ticket is issued by firstly activating the ticket and unique identification device, by activating the unique identification device to meet predetermined security requirements; assigning permissions to the unique identification device, printing the ticket, scanning the unique identification device and linking the unique identification device to the ticket being printed, such that either the ticket or unique identification device can be identified from details of either the ticket or the unique identification device.

In the event that an issued ticket is lost/stolen a new ticket may be printed and issued along with a new unique identification device. When the ticket is reissued the system identifies the old unique identification device issued with the lost/stolen ticket and updates the system to indicate the old unique identification device is no longer valid. This prevents lost/stolen unique identification device to be used by other parties. During the reissue process the permissions previously assigned to the old unique identification device may be transferred to the new unique identification device.

A unique code is written onto the device for security and verification purposes. The unique code is created by: reading an identification code of the device and a bar code associated with the device; amalgamating the identification code and bar code with a designated code to produce the unique code. The unique code also incorporates encryption. The unique code provides the device with a security structure which will prevent tampering and cloning of the device. When printing the ticket, relevant information from the ticket is copied and printed to the unique identification device. This may include the ticket number, bar code, and details of the concert.

Where a number of devices need to be made (say, for a large event, such as a concert) the unique identification device are activated in batches, whereby the unique code incorporates the specific batch details.

The unique identification device of a particular batch can be designated with certain attributes/permissions. For instance, a specific batch may be distributed to persons who have purchased a general entry ticket, whilst another batch may be distributed to persons who have purchased a VIP entry ticket. These attributes are considered a first level of validation whereby scanning of multiple people can be conducted quickly with immediate verification.

The scanning and activation of the unique identification device may be conducted simultaneously.

The ticket and unique identification device can be incorporated or provided separately. Where the ticket and the unique identification device are incorporated they are designed to be easily separated (by, for example, providing a perforated tab, breakable connection, etc.).

Preferably when scanning the unique identification device a scanning means scans and records the unique code, identification code or bar code or a combination of all.

Activation of the unique identification device may occur at any time and the activated unique identification device can be stored. When the unique identification device are required, the batch numbers can then have properties attributed thereto. As there is no need to process each unique identification device to assign these properties this process may be conducted remotely.

By assigning a batch to each unique identification device the unique identification device can be easily tracked.

The unique identification device may be in the form of an electronic device. Preferably the electronic device is in the form of a RFID. The RFID may be incorporated in a wrist band. Preferably the RFID circuit breaks when the wrist band is removed from a persons' wrist.

Preferably the system allows each unique identification device to be personalised. This information can then be used by organisers to identify who is coming to the event, and the demographics of the people allowing targeted marketing as well as ensuring the appropriate facilities are available at the event.

Upon receipt of the unique identification device the recipient may log on to a website using the unique code, identification code or bar code linked to the unique identification device or the ticket number. Once on the website an account may be created, or the person can log on to an existing account.

The person may also link their account to their account on other social network sites, such as Facebook®. This information may then be written to their unique identification device. Once the unique identification device has been personalised the person may participate in associated activities pre and post events. The user may purchase merchandise, upgrade their ticket to gain access to other zones. The website also allows a user to locate and/or link up with other friends who also attend the event.

When personalising the unique identification device the person may list any medical conditions and provide emergency contact details. Should the person become ill, a medical officer can scan their unique identification device and identify this information. If friends who are also in attendance at the event are also linked to the persons account a message may also be sent for them which will appear next time they are scanned.

From their account the person is also able to link funds to their unique identification device for use during the event.

The unique identification device may also be updated with details of the person's age once verified by an authorised person.

Once personalised, the person may update their unique identification device at the event.

When personalising a unique identification device, details on the server are updated to reflect the personalised information. This information may then be pushed to the unique identification device, or the unique identification device may be updated when scanned next.

Once personalised message may be assigned to the unique identification device. At the time the unique identification device is next scanned the message will appear on the scanning unit and can be shown to the person.

The unique identification device may not allow entry until such time as the unique identification device is personalised.

The unique identification device may store all essential information. This will still allow the scanning of the unique identification device should the scanning unit be off-line. When the scanning unit is back on line this information is then sent to the server. In one aspect of the invention the unique identification device stores all information with the exception of the funds which have been attributed to the unique identification device.

The system may also incorporate an App which may be accessed via a phone. The app may provide access to the persons account, provide information as to where linked friends have previously been scanned, allows a communal money fund, allow funds to be transferred to other unique identification device, provides event information. The App may be specific to that event.

Preferably the unique identification device is scanned upon every purchase. This allows the organisers to identify what people are purchasing. Should the person need emergency attention, it will also allow medical staff to identify what the person may have consumed.

Based on transaction history, unique rewards and giveaways may be issued to unique identification device which may be collected at various outlets.

The unique identification device may be issued with an unlock key. The unlock key will need to be used to transfer the ticket to another person. The reselling of the ticket may result in a fee being charged by the organisers such that they gain a percentage of the resale value.

The present invention further provides a system of collecting information from a unique identification device as herein before described.

The system comprises a scanning unit which scans the unique identification device at various stations, which may be mobile or fixed. For instance, the scanning stations may be located at entry gates, at retail outlets, such as refreshment stands, designated zones, e.g. VIP sections, first aid stations.

Preferably the scanning unit may store data in the event it is off-line. The stored data may then be uploaded to the server when it is back online.

The scanning unit may display the number of people who have entered a zone, and disallow the scanning of further unique identification device for entry into that area until people have left that zone. This assists with crowd control and allows volumes to be readily monitored. It also provides a history of the more popular areas of an event. This information can then be used to identify the most appropriate areas for marketing, event facilities. The information can also be used to react in real time to possible issues arising due to crowd movement.

The scanning unit may be locked after a period of inactivity. Preferably the scanning unit displays information relevant to the unique identification device.

Preferably the scanning unit allows the authorised operator to update details specific to the unique identification device. For instance, if a person has been ejected from a zone, the authorised operator may scan that persons unique identification device and update details attributed to that unique identification device to reflect the ejection. Should that person be scanned again by another scanning unit the operator will be notified of the ejection.

The unique identification device may be scanned by remote scanners whereby a period in one location may be activate a transfer of information whereby that information is uploaded to a website and may be used to update the persons profile in an account, such as a Facebook® account. If at a concert, this information may be cross referenced with the lineup schedule and the artist performing at that time, information may be sent to the account indicating that you liked that artist.

The present invention provides a ticket incorporating a unique identification device, whereby the unique identification device may be removed from the ticket and attached to the ticket purchaser, their phone or other belonging.

The ticket may also comprise one or more secondary identification means which may be removed and used according to its designated use. For instance the secondary identification means may be a sticker which may be removed and attached to the windscreen of the car to show parking permission. The secondary identification means may have a bar code for scanning by operators.

The unique identification device may also be provided to staff, whereby each staff group (e.g. cleaners, bar staff, security, etc) have different unique identification device, each having their own permissions and authorisations. This allows for monitoring of staff work hours. The unique identification device may send GPS location to track whereabouts of staff.

The unique identification device may be integrated with third party accreditation lists, volunteer lists, prior staff. The unique identification device allows collection of information relating to the persons activities.

System (Including Web Interface)

The system, which is described in more detail below, includes a web interface (through which the user creates an account) that enables the user to efficiently manage personal data stored on the database. Personal data includes data structures (e.g. tables, arrays or other suitable data structures) that include personal and identifying information about the user, including name, address, date of birth, financial information (such as credit card numbers) telephone numbers, e-mail addresses, etc.

The database may be designed, in some embodiments, to be capable of providing the details of the user to one or more remote computing systems. For example, credit card details may be provided to a remote payment gateway where the user purchases a product.

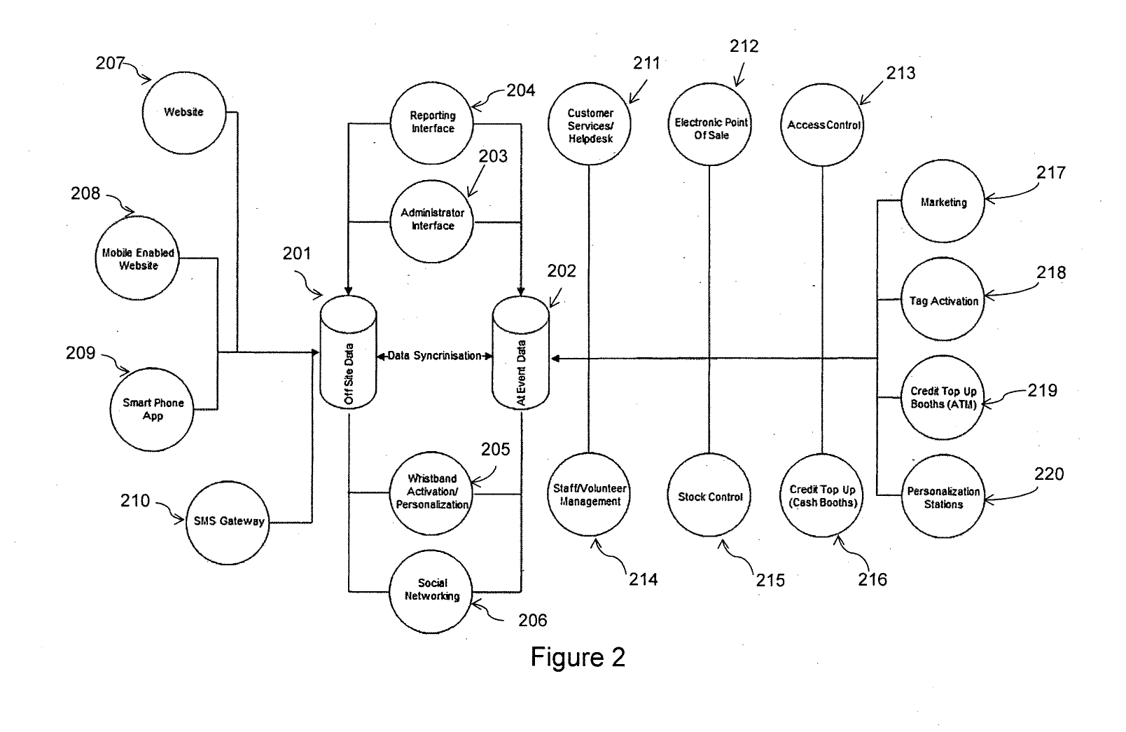

FIG. 2 is an example block diagram of software components or modules of an example database environment which may be operated on the computing system of FIG. 1. In particular, FIG. 2 depicts an example “off site” database 200 and an “on site (or “at the event”) database 201 which are arranged to synchronize data at regular, predetermined times (or on an “on demand” or forced synchronization, as required. The databases may be accessed directly through either a reporting interface 203 or a administrator interface 204, and directly interact with external devices through a wristband activation portal or device 205 and a social networking interface 206.

The components of the illustrated databases 200 and 201 provide, in conjunction with the computing system of FIG. 1, various functions and/or services related to the propagation of data between ‘off site’ devices, such as a website 206, a mobile device website 207, a smart phone app 208 and a SMS gateway 209 and the database 200. In particular, the off site interaction is generally related to functions that involve the entering of personal information, the update of personal information, the loading of credit into a personal account (or alternatively, the entering of financial information) and the creation or changing of certain settings.

For example, the website 206 may obtain personal data from a user to set up an account which entitles the user to then purchase a unique identification device which may then be used at an event. As noted, personal data includes data structures that reflect personal information about or related to a particular user. This data may be used to provide other functions, such as answering queries regarding purchases by the user, distributing information about users to third parties (e.g. event organisers or employees), managing the actions of the user (e.g. preventing the user from buying further alcoholic drinks or from making further purchases once a predetermined limit is reached), or any other suitable purpose.

In more detail, the data may be used ‘at the event’ via any one of a number of mechanisms or access points. For example, database 201 may interface with a customer services desk 210, an electronic point of sale system 211, an access control point (e.g. a boom gate) 212, a hand held device used by a staff member 213, a stock control point/device 214, or a credit top up point 215.

There may also be functions associated with the at the event database 201, such as a marketing function 216, a tag activation function 217, a credit top up function 218, and a personalization function 219.

It will be understood that FIG. 2 outlines one possible embodiment of the invention and other embodiments may provide some (but not all) of the modules and functions described herein.

The off the site database 100 and at event database 101 may store data in any suitable format. In one embodiment, each of the databases may include a collection (e.g., a list, array, table, set, or similar data structure) of indications of one or more events, areas, products, items, or services that the user is entitled access or consume. In another embodiment, the data may include one or more categories, classes, or types of products or items, where the categories are defined elsewhere to specify the particular products or items included. For example, a user may specify that they wish to be able to purchase a maximum of six standard drinks during the course of an event. The types of drinks that are classified as ‘standard drinks’ may be specified elsewhere in another database, such that each time a user purchases a drink, a comparison is made with the other database and the user's total consumption of drinks is updated accordingly.

The data may also include access rights, possibly in association with particular areas at an event. For example, the data subscription may specify that the user may enter a general area, but not a VIP area. In some embodiments, users may subscribe to or otherwise become associated with a “level of service,” which may be or include one or more subscriptions to one or more extra services.

In at least some embodiments, goods or services may be obtained by users in exchange for payment or other consideration to a third party. For example, a user may be able to use their unique identification device to purchase goods from conventional retail stores using read-write access to personal data related to financial information (e.g., bank account numbers, bank balances).

The unique identification device, in some embodiments, may also partly manage data in an ‘off line’ capacity. For example, the unique identification device may manage (i.e., add, update, delete) data contained in a memory or processing chip incorporated into the unique identification device.

The unique identification device may provide controlled access to the personal data stored in the memory or processing chip, by ensuring that requests for personal data are in accordance with a predetermined process. For example, the unique identification device may interact with either of databases 100 or 101, by transmitting, via an access point, one or more data items requested and receiving an indication of whether or not access is in accord with the predetermined process.

It will be understood that the memory in the unique identification device may be a non-volatile memory, such as flash memory, that is embedded in, or coupled to, the unique identification device. In some embodiments, the memory may be removably coupled to the device (e.g. where the unique identification device is a mobile phone). The memory may store data in an encrypted format, as required.

Note that one or more databases, one or more interfaces, and one or more functions may be combined in various ways. In one example, the databases may interact with a single interface (for security purposes). In another example, a user may utilize multiple logins to represent multiple distinct identities, such as an “employee” identity, a “personal” identity, etc. This may be useful where the user wishes to keep some information separate or private. To achieve this, the user may couple one identity to one unique identification device, couple a second identity to a second unique identification device, etc.

The databases 200 and 201 manage the acquisition of personal data from the users and the propagation of the data on behalf of the consumer. Example propagation of data may include data being sent to online retailers, financial institutions, government agencies, or any other third party that has a legitimate interest in the data.

In addition, in some embodiments, the user may be provided with incentives to provide additional information or to allow their information to be provided to third parties for marketing purposes. For example, in exchange for discounts, monetary rewards or other incentives, the user may allow access to their transaction history to third parties that use the information for marketing purposes.

Different architectural arrangements than the one illustrated are contemplated. For example, although two databases 200 and 201 are shown, the two databases may reside within a single computing system, or the two databases may be a single database with separate tables.

Unique Identification Device

The unique identification device may take the form of a ticket or wristband (as previously described), but may also take the form of any appropriate device, such as a RFID tag, a smart card, a credit card with a built-in chip, etc.

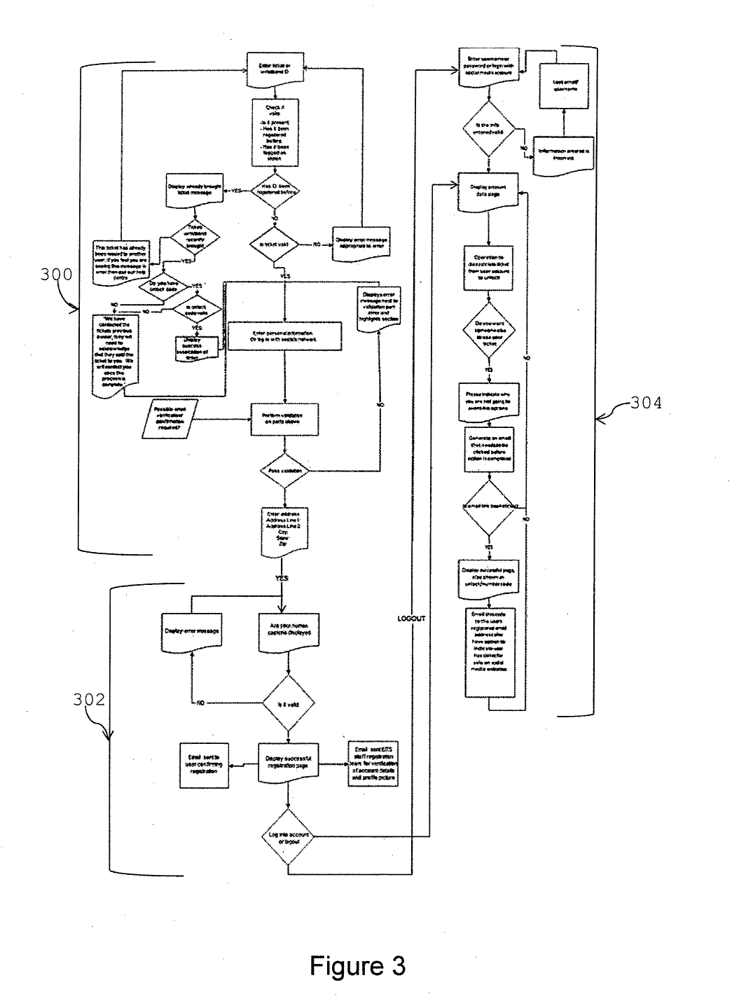

As described previously, the unique identification device is activated, and information is loaded onto the unique identification device in any one of a number of possible ways. Some example ways of activating and loading information are described with reference to FIGS. 3 to 6.

Referring to FIG. 3, there is depicted a flow chart which depicts a process flow for the interaction of the system as a whole with a unique identification device. Step 300 outlines the steps of checking to determine whether a unique identification device is valid and then allowing a user to register and associate themselves with the unique identification, device. Once the registration is finalised, the user at step 302 can log out. Thereafter, if the user wishes to log back into the system, they can do so by following the process outlined generally at step 304.

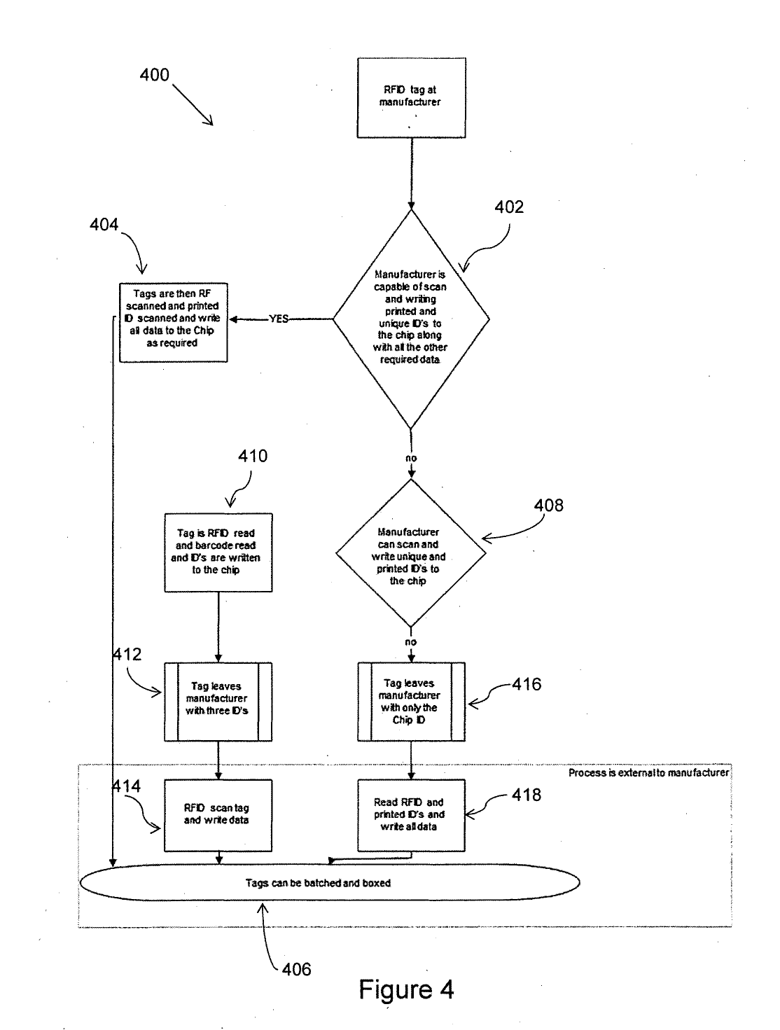

Referring to FIG. 4, there is shown a process for attaching a unique identification code to a unique identification device. If the manufacturer of the device is capable of scanning and writing to the RFID chip on the unique identification device all relevant data (at step 402), the method proceeds to step 404 and the data is written to the RFID, which can then be boxed up for delivery at step 406.

If the manufacturer can only scan and write the unique and printed identification code (at step 408), then the RFID chip is read and the barcode is read and the ID's are written to the chip (step 410). The device then leaves the manufacturer (step 412) and is scanned and written with data at a local location (step 414).

If the manufacturer cannot write the unique identification code, the tag leaves the manufacturer with only the chip ID (step 416). The device scanned and written with the ID and the data at a local location (step 418).

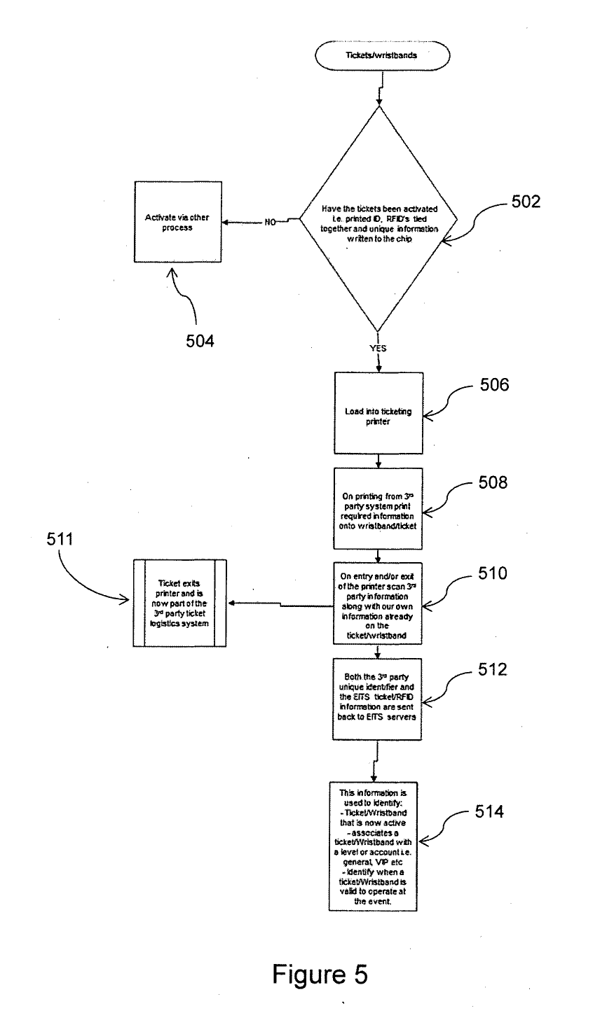

Referring now to FIG. 5, there is depicted a process for creating tickets which are associated with the RFID tag. If the ticket has not yet been activated (step 502), then the ticket must be activated via another process before any further steps are taken (step 504).

If the ticket has been activated, then the ticket is loaded into a printer (step 506). The required third party information is then printed on the ticket (step 508). Subsequently, this allows third party information to be scanned and identified (step 510), which then places the ticket information in a third party database (step 511).

Subsequently, both the ticket information and the third party information are sent to the database (step 512), which can then be used to identify a ticket with a person and an event (step 514).

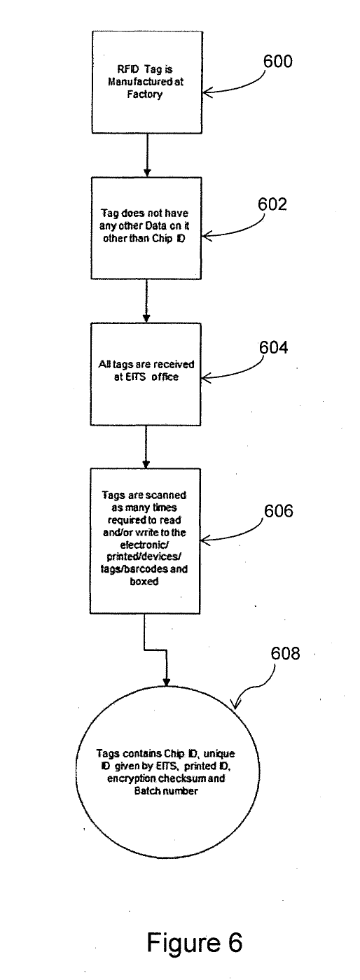

Referring now to FIG. 6, there is depicted a process for preparing unique identification devices for use. At step 600, the unique identification device is manufactured with no data (step 602). The unique identification device is subsequently received by a supplier (step 604), who then reads and writes onto the devices as required (step 606). The device then contains all information, as may be required (step 608).

Use of System

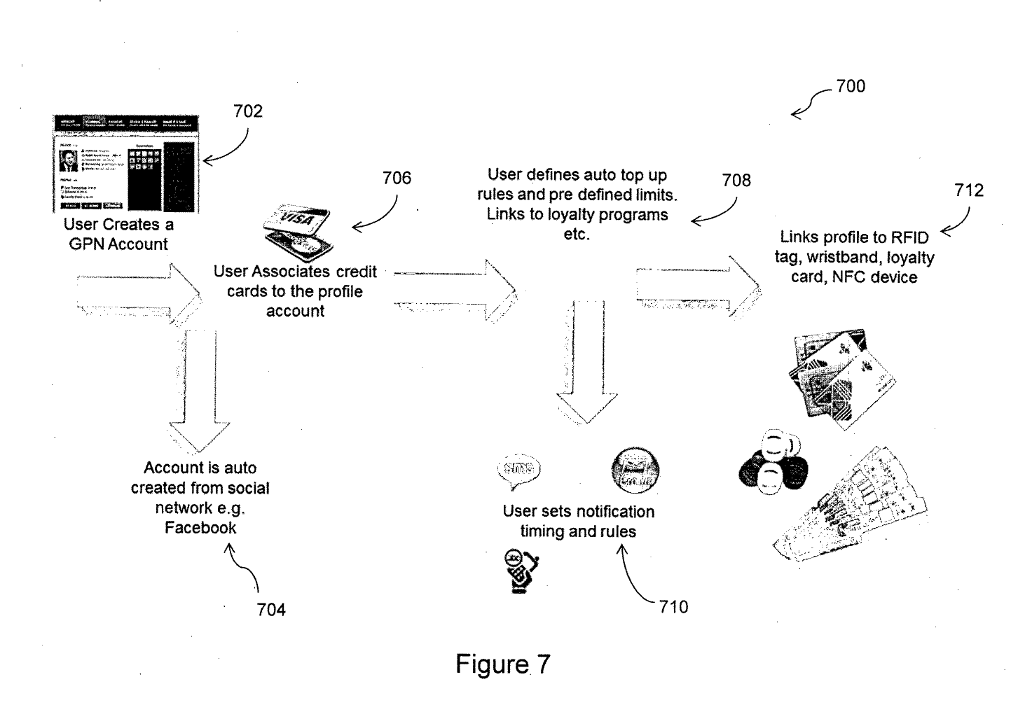

Referring now to FIGS. 7 to 11, there is shown a series of process flows for various aspects of account creation and use. While FIGS. 2 through 6 refer to a specific use of the system and unique identification devices for the purpose of events, such as concerts, sporting events, etc., the example given with reference to FIGS. 7 to 10 describes a more general system which is useable for any type of financial or non-financial transaction.

Referring to FIG. 7, there is shown generally at 700 a process for creating an account on a system in accordance with an embodiment of the invention. At step 702, the user creates an account by interacting with a web interface. In an optional step 704, an account may be automatically created by utilizing information from an existing account (e.g. a social media account, such as a Facebook account or a LinkedIn account). At step 706, the user enters appropriate payment details to allow funds to be deducted when a user utilizes their unique identification device. The payment details may be related to a credit card, or they may be related to another monetary payment system, such as a direct debit facility or a PayPal account.

Once the user has set up the basic account details, the user may optionally, at step 708, enter predefined limits or actions. These may include limits to the amount of money that may be spent, the frequency of monetary top-ups to the account, links to loyalty programs, etc. At this time, the user may also, optionally, at step 710, decide how they will receive notifications and reminders. For example, the user may decide to receive a SMS when their account funds are low, or where a predetermined spend limit has been reached.

Once the user has set all parameters regarding their desired spend limits and notifications, the user may associate their account with one or more unique identification devices at step 712. The unique identification devices may include a RFID card or tag, a wristband, or even a near field communication chip embedded in another device (e.g. a smartphone).

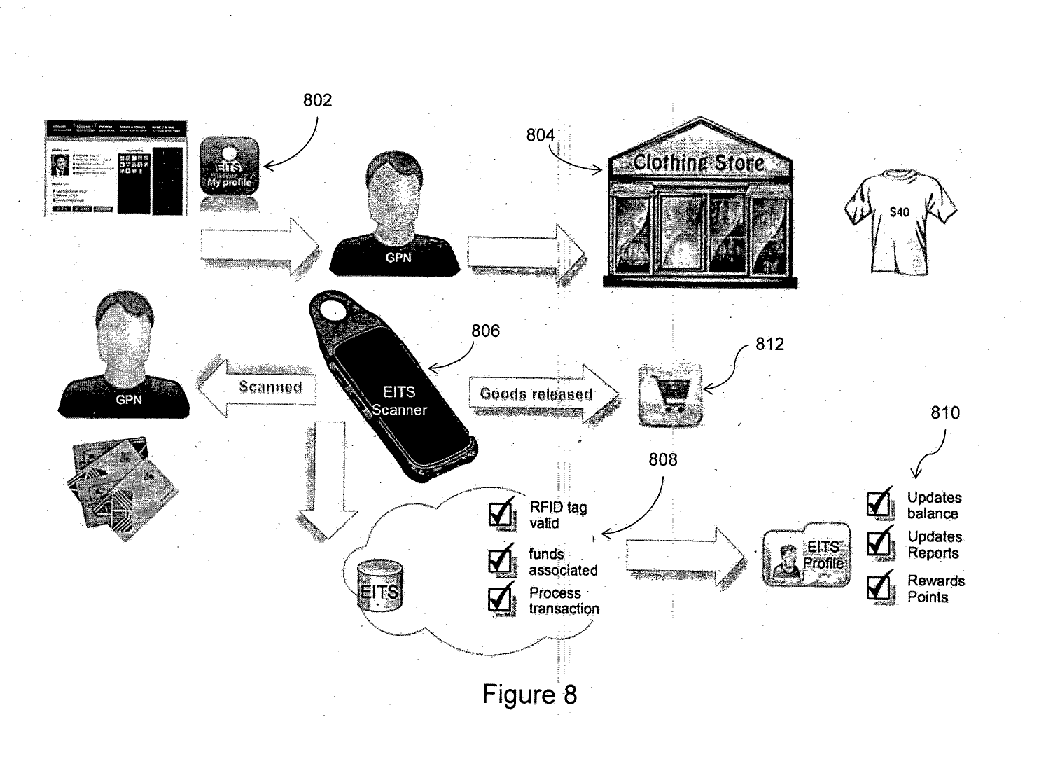

Referring now to FIG. 8 through 10, once the user has set up an account, the user can use the account (via the unique identification device) to pay for purchases.

Referring to FIG. 8, at step 802, the user has established their profile and goes to a store with their general purpose unique identification device to purchase goods. The general purpose identification card is scanned at step 806, and a comparison is made to details residing in the database to ensure that the unique identification device is valid, funds are associated with the device, and that the transaction can be processed (step 808). When the transaction is processed, all relevant details in the database are updated (step 810) and the goods are released (step 812). This is the simplest use of the general purpose identification device, where the device is used in a manner akin to a convention credit card. However, as the device is associated with a specific user profile, information regarding the transaction is associated with the profile, in a manner that is not possible with a conventional credit card, direct debit card or other conventional payment method.

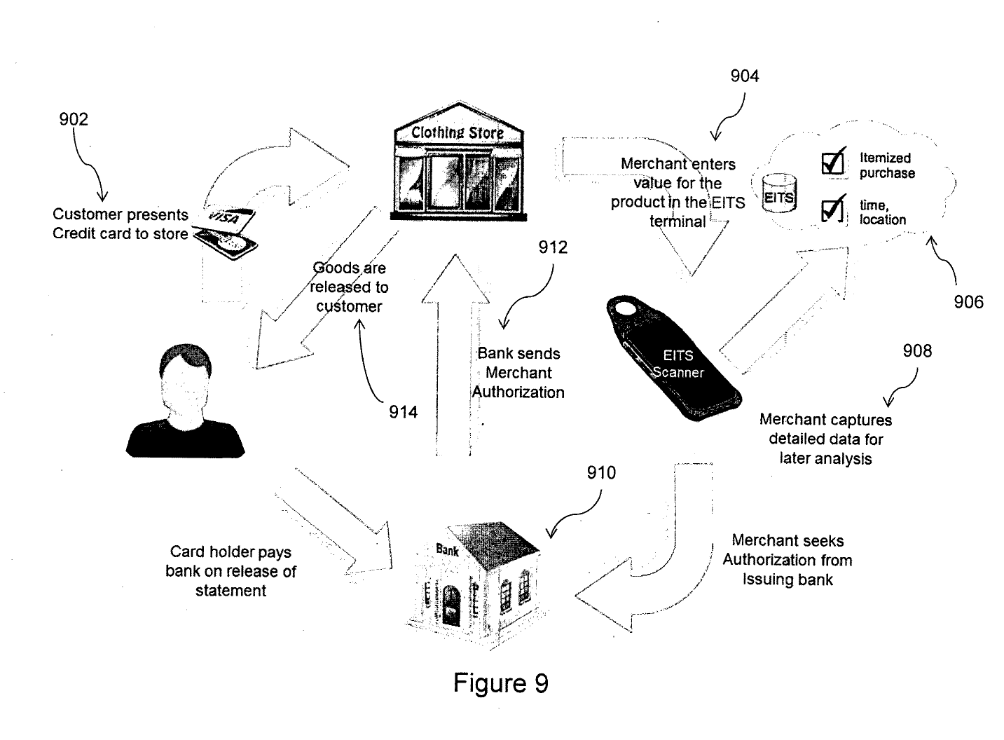

Referring to FIG. 9, there is shown a more sophisticated system which utilizes a conventional credit card which incorporates a unique identification device in the form of a RFID chip. The user presents the card to the store at step 902, and the merchant utilizes a terminal which is capable of interacting directly with the database at step 904, to capture information regarding the exact items purchased and the time and location of the purchase (step 906). The merchant also captures the data (step 908) then seeks authorization from a financial institution for the purchase in a conventional manner at step 910 (for example, through a payment gateway). Once the financial institution authorizes the transaction (step 912), the good are released to the customer (step 914). This is a hybrid model which allows for the capture of data in the system without the need for a ‘dedicated’ device.

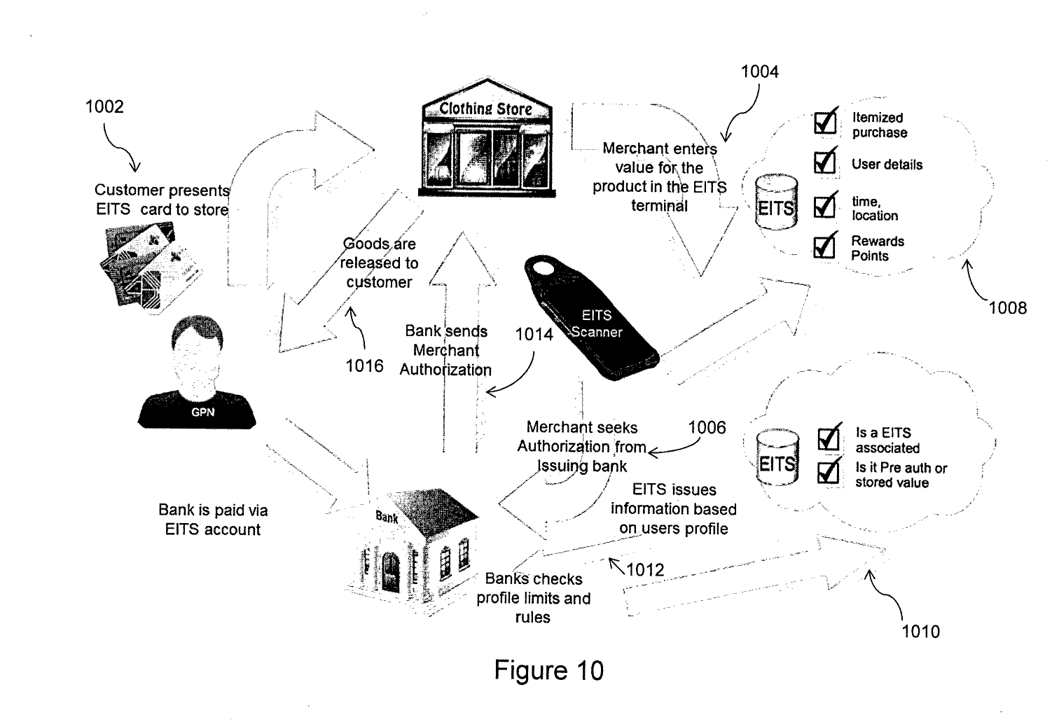

Referring now to FIG. 10, there is shown a full system which integrates the unique identification device into a conventional credit card. The user presents the card to the store at step 1002, and the merchant utilizes a terminal which is capable of interacting directly with the database at step 1004, to capture information regarding the exact items purchased and the time and location of the purchase (step 1008). The merchant then seeks authorization from a financial institution for the purchase in a conventional manner at step 1006 (for example, through a payment gateway). In this embodiment, the financial institution queries the database to retrieve information regarding the user's limits and rules, and also provides to the database information based on the user's profile (steps 1110 and 1112). Once the financial institution authorizes the transaction (step 1014), the good are released to the customer (step 1016). This is an integrated model which allows for the capture of data in the system between the merchant, the financial institution and the user.

Advantages

The embodiment described herein provides a number of advantages.

Firstly, the embodiment provides a physical device thatlinks consumers to an online portal with a consumer profile, such that the user can manage their profile through any internet enabled device.

Secondly, the embodiment enables the user to manage the profile by setting rules, preferences & limits, as users have ‘opt in’ and ‘opt out’ options.

Thirdly, if a physical device is lost, a user disassociates the device online, thereby rendering the device useless and removing the potential for misuse or fraud.

Fourthly, the embodiment captures the full purchasing profile of a user, including real time detailed analytics. Such information provides a baseline for users to better interact with suppliers of goods and services.

Lastly, the embodiment can be integrated into all types of social media, to provide users with a known yet rich experience.

Disclaimers

Throughout this specification, unless the context requires otherwise, the word “comprise” or variations such as “comprises” or “comprising”, will be understood to imply the inclusion of a stated integer or group of integers but not the exclusion of any other integer or group of integers.

Those skilled in the art will appreciate that the invention described herein is susceptible to variations and modifications other than those specifically described. The invention includes all such variation and modifications. The invention also includes all of the steps, features, formulations and compounds referred to or indicated in the specification, individually or collectively and any and all combinations or any two or more of the steps or features.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

Although not required, the embodiments described with reference to the method, computer program, data signal and aspects of the system can be implemented via an application programming interface (API), an application development kit (ADK) or as a series of program libraries, for use by a developer or programmer, for the creation of software applications which are to be used on any one or more computing platforms or devices, such as a terminal or personal computer operating system or a portable computing device, such as a smartphone or a tablet computing system, as a component within an operating system, or within a larger server structure, such as a cloud computing ‘data farm’ or within an enterprise computing system.

Generally, as program modules include routines, programs, objects, components and data files that perform or assist in the performance of particular functions, it will be understood that the functionality of the software application may be distributed across a number of routines, programs, objects or components to achieve the same functionality as the embodiment and the broader invention claimed herein. Such variations and modifications are within the purview of those skilled in the art.

It will also be appreciated that where methods and systems of the present invention and/or embodiments are implemented by computing systems or partly implemented by computing systems then any appropriate computing system architecture may be utilised. This includes standalone computers, network computers and dedicated computing devices (such as field-programmable gate arrays).

Where the terms “computer”, “computing system” and “computing device” are used in the specification, these terms are intended to cover any appropriate arrangement of computer hardware for implementing the inventive concept and/or embodiments described herein.

1. A system for the collection and updating of information comprising an electronic reader arranged to receive information from one or more unique identifying devices, at least one computing system arranged to receive the information from the reader, wherein the computing system receives the information from the reader and processes the information in real time to determine whether an action should be taken; and wherein, the one or more unique identification devices are adapted to process the information internally when the computing system is not linked to the reader and update the computing system with the processed information when the one or more unique identification devices re-establish a link with the computing system.

2. The system as claimed in claim 1, further comprising a plurality of scanning devices arranged to scan the at least one unique identifying device.

3. The system as claimed in claim 2, wherein the plurality of scanning devices establish a communications network within a predetermined area.

4. The system as claimed in claim 2, wherein the communications network utilises one of a wireless computing communication standard and a wireless telecommunication standard.

5. The system as claimed in claim 1, wherein the system may assign each one of the one or more unique identification devices to a person or object.

6. The system as claimed in claim 2, wherein the scanning device is arranged to automatically scan the one or more unique identifying devices when the one or more unique identifying devices fall within a prescribed range of the scanning device.

7. The system as claimed in claim 1, wherein the unique identifying device includes a radio frequency identification chip.

8. The system as claimed in claim 1, wherein the computing system further comprises a database arranged to store the information collected.

9. The system as claimed in claim 8, further comprising a comparison module arranged to compare the information received to information in the database.

10. A method for issuing an updateable unique identifying device associated with a user or object, comprising the steps of activating a unique identifying device to meet predetermined security requirements; assigning permissions to the unique identifying device; associating the unique identifying device with a person or object, wherein actions by the person or object are loggable by a system interacting with the device; wherein, a reader is used to interface between the unique identifying device and the system; and wherein the actions by the person or object are loggable on the unique identification device when the link between the reader and system is down.

11. The method as claimed in claim 10, comprising the further step of activating the device by the steps of reading an identification code of the device and a bar code associated with the device and amalgamating the identification code and bar code with a designated code to produce a unique code.

12. The method as claimed in claim 11, wherein the unique code is encrypted.

13. The method as claimed in claim 10, comprising the further step of activating a plurality of unique identification devices in a substantially simultaneous or contemporaneous manner, whereby each unique code associated with each device incorporates information related to the devices which were activated contemporaneously.

14. The method as claimed in claim 13, wherein the activation of the unique identification devices are conducted simultaneously.

15. A system for determining whether an action should be taken comprising at least one computing system arranged to receive information from one or more unique identifying devices, the information pertaining to at least one action initiated by a user or object, wherein the computing system includes a database and a processor arranged to receive the information, process the information to determine whether the action falls within a predetermined set of allowable actions; and wherein, when the computing system is down, the one or more unique identifying devices is adapted to receive and process the information to determine whether the action falls within a predetermined set of allowable actions.

16. A system as claimed in claim 15, wherein the information is collected from the one or more unique identifying devices via a telecommunications infrastructure.

17. A system as claimed in claim 15, wherein each of the one or more unique identification devices is associated with a particular person or object.

18. A system as claimed in claim 15, wherein the unique identification device is activated upon the person or object entering a specific area.

19. A system as claimed in claim 15, wherein the unique identification device is activated upon the person or object initiating an action.

20. A system as claimed in claim 15, wherein if the action falls within the set of predetermined actions, the processor issues a command to allow the action.

21. A system as claimed in claim 15, wherein if the action falls outside the set of predetermined actions, the processor issues a command to disallow the action.

22. A system as claimed in claim 15, wherein the action further includes sending an electronic signal to the person or object.

23. A system as claimed in claim 15, wherein the action further includes sending an electronic signal to a third party.

24. A system as claimed in claim 22, wherein the electronic signal includes a message.

25. A system as claimed in claim 15, wherein the action initiated by the user is a request to effect a financial transaction.

26. A computer program including at least one command, which, when executed on a computing system, is arranged to perform the method steps of claim 10.

27. A computer readable medium incorporating a computer program as claimed in claim 26.

28. A data signal encoding at least one command and being arranged to be receivable by at least one computing device, wherein, when the encoded command is executed on the computing system, the computing system performs the method steps claim 10.
